(19) United States
(12) Patent Application Publication
(10) Pub. No.: US 2010/0110724 A1
(43) Pub. Date: May 6, 2010

(54) THIN FILM LIGHT DIFFUSION GUIDE

(76) Inventor: Scott Moncrieff, La Jolla, CA (US)

Correspondence Address: MINTZ, LEVIN, COHN, FERRIS, GLOVSKY AND POPEO, P.C, ONE FINANCIAL CENTER, BOSTON, MA, 02111, US

(21) Appl. No.: 12/606,152

(22) Filed: Oct. 26, 2009

Related U.S. Application Data
(60) Provisional application No. 61/108,477, filed on Oct. 24, 2008.

(51) Int. Cl. F21V 7/04; G02B 6/10

(52) U.S. Cl. 362/606; 385/131; 362/627

(57) ABSTRACT

A light guide device and method for making the same are disclosed. A light guide includes a thin film of light transmitting material, and a light-emitting device connected to a first edge of the thin film. The light guide further includes a printed pattern abutting a first side of the primary guide and comprised of light reflecting ink and arranged to reflect the light from the light emitting device, and a guide frame framing the remaining edges of the primary guide other than the first edge.

### CROSS REFERENCE TO RELATED APPLICATIONS

This application claims the benefit of priority under 35 U.S.C. §119 to U.S. Provisional Patent Application Ser. No. 61/108,477, filed on Oct. 24, 2008, entitled, “THIN FILM LIGHT DIFFUSION GUIDE”, the entire disclosures of which is incorporated by reference herein.

### BACKGROUND

The present invention relates to light guides, and more particularly to a device to selectively direct light from high intensity side-emitting light emitting diodes (LEDs).

Various forms of high intensity, side-emitting LEDs have presented greater opportunities for lighting applications of smaller scale, such as thin-film application or thin devices or components. The conventional techniques for using high intensity, side-emitting LEDs with light guide films involve piercing, embossing, laser etching, or other mechanical means of deforming what is typically an uninterrupted, smooth, and glossy surface of the light guide film, and use multiple layers of film to contain the etchings or create reflective and diffusing layers.

### SUMMARY

This document discloses a light guide, and technique for forming the same, for selectively directing light from edge-mounted, side-emitting LEDs or other high-intensity thin light source.

In one aspect, light guide for a light-emitting device is presented. The light guide includes a primary guide comprising a thin film of light transmitting material, and having at least one edge to which the light emitting device is connected and into which the light emitting device emits light. The light guide further includes a printed pattern abutting a first side of the primary guide and comprised of light reflecting ink and arranged to reflect the light from the light emitting device.

In another aspect, a light guide includes a thin film of light transmitting material, and a light-emitting device connected to a first edge of the thin film. The light guide further includes a printed pattern abutting a first side of the primary guide and comprised of light reflecting ink and arranged to reflect the light from the light emitting device, and a guide frame framing the remaining edges of the primary guide other than the first edge.

Various methods for making and constructing the light guides disclosed herein are also presented. The details of one or more embodiments are set forth in the accompanying drawings and the description below. Other features and advantages will be apparent from the description and drawings, and from the claims.

### BRIEF DESCRIPTION OF THE DRAWINGS

These and other aspects will now be described in detail with reference to the following drawings.

FIG. 1 illustrates a light guide and image-rendering layers.

FIGS. 2A and 2B illustrate a graphic lens with a printed graphic image.

FIG. 3 shows a liner arrangement for framing or lining a light guide.

FIG. 4 is an exploded view of a light device including high-intensity, side-emitting, side-positioned LEDs.

FIG. 5 shows an alternative light device.

FIG. 6 illustrates construction details for a light guide assembly that is optimized for a focused illumination.

FIG. 7 illustrates construction details for a light guide assembly that is optimized for a diffused illumination.

FIG. 8 illustrates construction details for a typical graphic lens/display.

FIG. 9 shows an example of a multi-chip light guide assembly having multiple LEDs and associated light guides positioned within a common frame.

FIG. 10 illustrates a preferred exemplary implementation of a light guide assembly for focused illumination.

FIG. 11 illustrates a preferred exemplary implementation of a light guide assembly for diffused illumination.

FIG. 12 illustrates an implementation suitable for light containment.

Like reference symbols in the various drawings indicate like elements.

### DETAILED DESCRIPTION

This document describes a light guide, and technique for forming the same, for selectively directing light from side-emitting LEDs or other high-intensity light source through a thin film, for static or active backlit displays or other illumination applications. The light guide can effectively backlight or illuminate multiple selected translucent areas of a printed display at various distances along a thin film light guide from the light source or sources, with a substantially even light distribution. As few as a single LED can be used with the presently described devices and techniques, and there can be any number of source LEDs used within a common frame or light guide assembly. Further, the present devices and techniques can control and adjust light intensity at various locations of the light guide.

In preferred implementations, a light guide includes a primary guide, a reflector, a guide frame, and a printed pattern. The primary guide is preferably a thermo plastic such as polymethyl methacrylate (PMMA) or polycarbonate (PC) clear plastic film, with or without PSA on either one or both sides. The primary guide can have any thickness, but is preferably 0.010″-0.100″ thick, such as having a 0.020″ thickness. The reflector can be a white film applied to the primary guide, and can be made from polyethylene terephthalate (PET) or polypropylene (PP), as examples, with or without PSA.

The guide frame is at least a three-sided frame of the primary guide, and can be any thickness. Preferably, the guide frame has a thickness of 0.010 to 0.030 (must be at least as thick as the light guide film itself including adhesive), of white (or black in certain applications that require maximum blocking properties) opaque film with PSA on at least two opposing sides, along the primary guide generally in the direction of the traveling light. The printed pattern can be a white reflective print material or light-catching material which is applied to the primary guide as determined by the design and/or specific lighting requirements. Optionally, the printed pattern can include one or more piercings or detents into the primary guide for special light-catching effect.

An image-specific master pattern is generated based on the areas to be illuminated. The pattern is then transferred or applied to the primary guide. The pattern can be in the form of a 0.0005″ thick film of semitransparent white coating that is adapted to permanently adhere to the particular substrate used. This pattern can be applied using a silkscreen process, pad printing or other process capable of transferring an at least 0.0002″ layer of ink. The pattern layer, once applied to the primary guide, can be 2 to 15 microns thick. The patterned area transmits light from the LED source when the LED source is on. The light intensity of the light that is transmitted through the pattern can be adjusted by using different densities of the coating, and/or different pattern shapes (i.e. shapes that make up the pattern, such as dots or circles, squares, diamonds, etc.), depending on the desired effect.

FIGS. 1-3 illustrates various implementations of a device and/or light guide. While these devices and light guides are described in terms of preferred thicknesses and materials, those having skill in the art will recognize that other thicknesses and materials can be used. FIG. 1 illustrates a device 100 employing a light guide 102 in accordance with some alternative implementations. While the device 100 will be the light guide 102 is preferably formed of 0.015″-0.020″ polycarbonate. The device 100 further includes 0.0005″ selectively located adhesive 108 (i.e. in areas without printing to be illuminated), which in turn can be protected by a 0.0008″ polyester liner 110, handling. A 0.0005″graphic image layer 104 is applied to the opposite side of the light guide 102, according to one of a number printing techniques described above. A second adhesive layer 106 is applied to the light guide, preferably on areas that are not printed, or to assist in defining the printed image. The adhesive on the reflector side of the light guide may or may not be selectively applied.

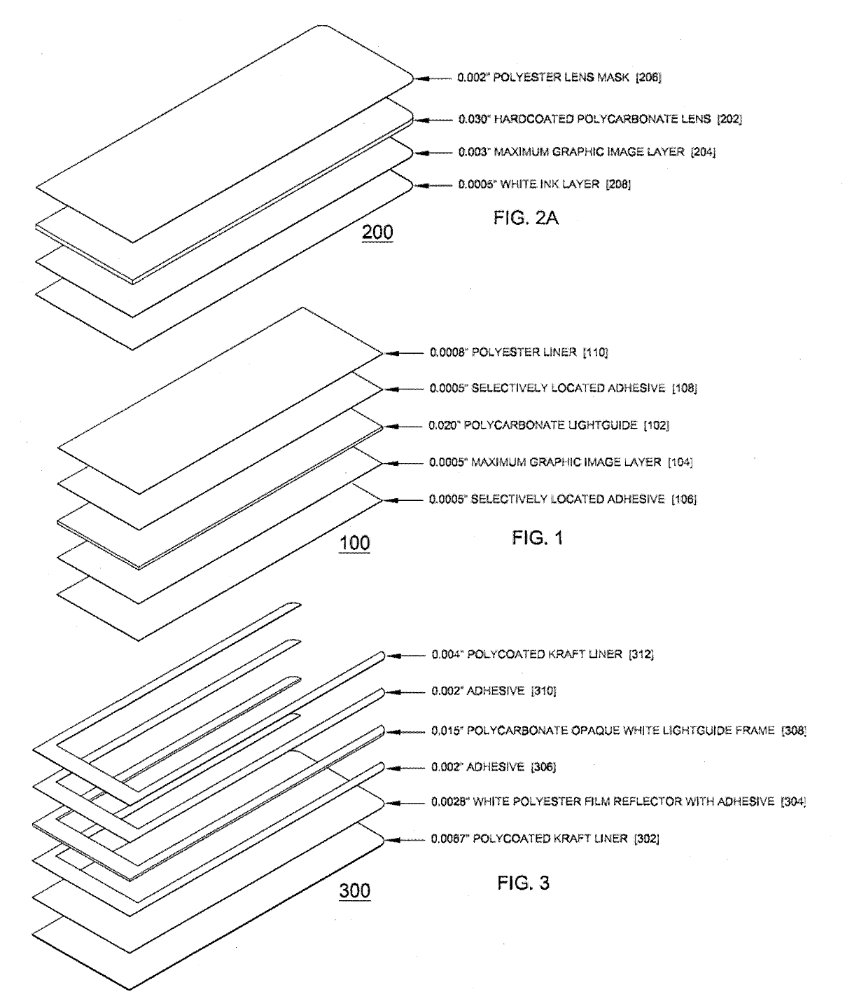

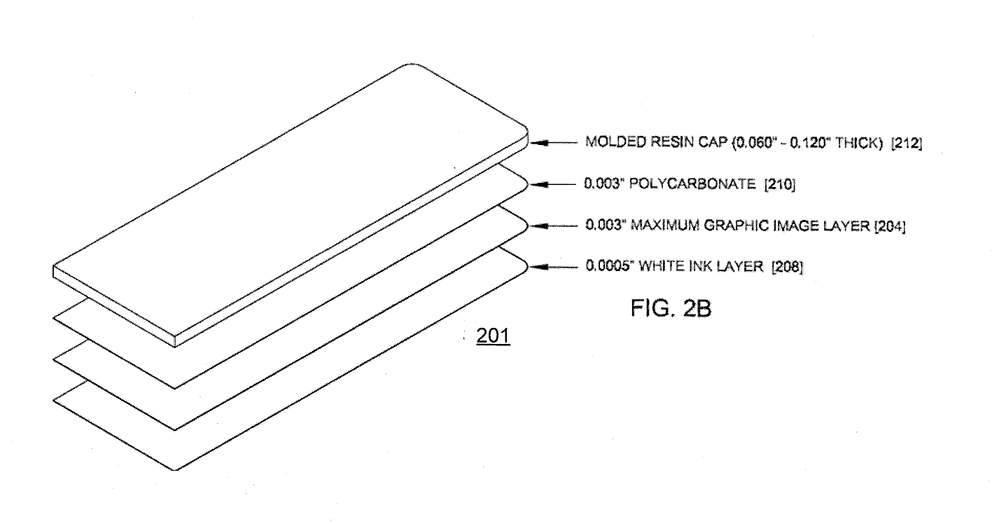

FIG. 2A illustrates a graphic lens component 200 of a light guide system, and shows the second surface, screen-printed image for being selectively lit based on the specific image and users specifications. That image layer 204 may be up to 0.002″ thick depending on how many layers of ink it takes to render the graphic and provide the desired light blocking properties in the area of the LEDs, if the LEDs are in fact positioned in the viewing area of the particular device. If the LED's can be positioned outside of the viewing area, the light masking feature is not necessary. A preferably 0.010″-0.030″ polycarbonate layer 202 (typically hard coated for scratch resistance, but not required) has the image printed on it in both opaque and semitransparent inks to allow specific areas of the image to be illuminated, while at the same time blocking light from view where no illumination is desired. Optionally a final layer of white ink 208 is printed over the last graphics layer 204 of ink in order to reflect light back into the light guide and further enhance the light output of the finished component.

FIG. 2B illustrates an alternative implementation of a graphic lens component 201, including a graphics layer 204 coated with a polycarbonate layer 210, which in turn is layered by a molded resin cap 212. A white ink layer 208 is printed or laid on the graphics layer.

Features of the graphic lens component 200 or 201 include the ability to print light transmitting areas of color that appear to be the specified color both when viewed solely in reflective light (i.e. unlit state) as well as with the light guide illuminated (i.e. lit state). This can accomplished by matching the color for viewing in reflected light, applying one or more layers of semi transparent white ink, and applying the original color behind the transparent white layer/s in its original, or in a potentially a modified formula, to produce the desired color with the light guide activated or illuminated. This can also be accomplished using digital printing techniques in combination with screen printed layers to achieve the desired effect in both the lit and unlit states. In some implementations, the color image is applied first followed by one or more layers of semitransparent white inks, followed by another “in register” print of the digital color image. This is then backed up with additional layers of screen printed opaque ink as required to block the light where it is not wanted, and finally, laminated as required to a thicker substrate depending on the application. This can be performed on a digital press such as the Indigo 4000 series machine.

FIG. 3 illustrates an optional liner arrangement (frame/reflector assembly) 300, for lining and containing light that travels through the light guides described above, or through variants thereof. The liner arrangement 300 includes a 0.0067″ polycoated kraft liner 302, coated with a white polyester film reflector with adhesive 304, or with selectively deposited adhesive 306. The liner arrangement 300 further includes a 0.017″ polycarbonate (or any opaque plastics substrate suitable for the particular application) opaque white lightguide frame 308, which is further coated by a thin coat of adhesive 310, and to which a 0.004″ polycoated kraft liner 312 is adhered. The liner 312, lightguide frame 308 and adhesive layers 306 and 310 are preferably sized and shaped to frame a light guide and image layers according to any of the implementations described above.

The one or more LEDs may be placed along one or more edges of a particular light guide depending on design and light intensity requirements. In some implementations, the LEDs are surface mounted, either on a PCB, thin film flex circuit or membrane circuit, and the light guide assembly is adhered to the specified substrate allowing the LED's to pass through the LGA reflective layer and match to the light guide edge as designed. In alternative implementations, the LED film circuit may mounted directly to the reflector film and align to the edge of the light guide or in some cases be mounted directly to the graphic lens.

The devices and techniques described herein can be used for any application in which a high intensity backlit display image is desirable, and/or in which a thin profile is needed due to space constraints. Examples of applications include electronic devices and accessories that have low power demands and limited space. Other applications include automotive devices such as dashboards or lighted controls, and electronics such as illuminated badges, logos or safety and warning lighting. The ability to provide illuminated product identification can help in branding, identification, nameplating, and/or unique signage. Other applications include general sign applications including street or highway signage as well as POP and advertising applications.

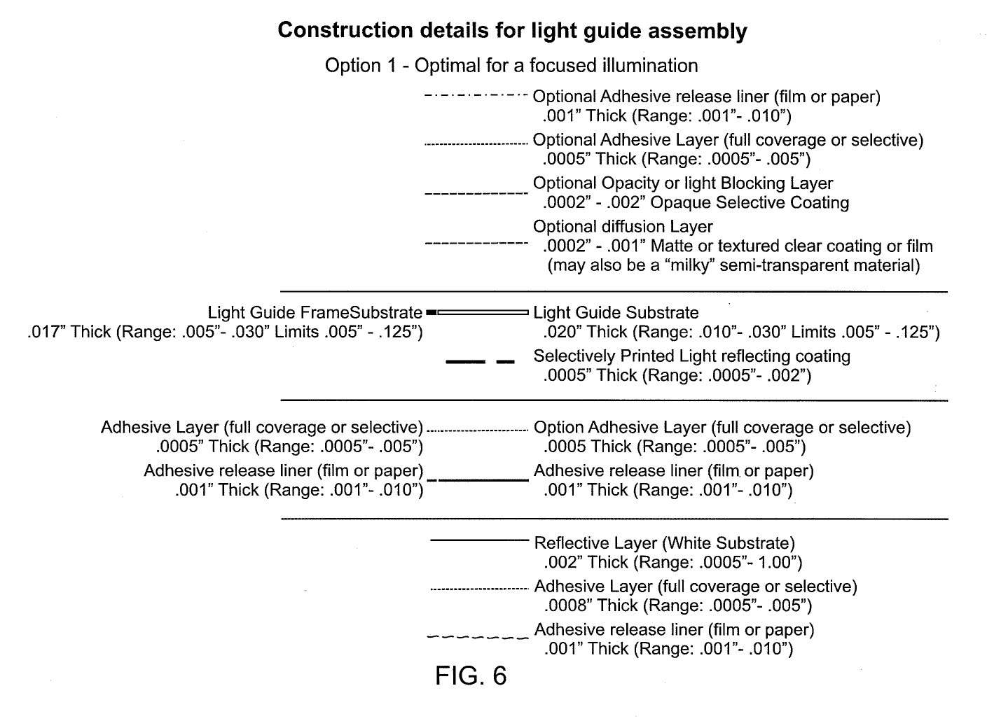

One method to achieve the brightest intensity in a controlled and very focused way is to print white light reflecting ink on the side of the light guide that will be directly adjacent to the bottom reflector film when assembled. Alternatively, the print may be on the opposite side of the film. In this alternative the effect is a much more diffused illumination with a lower level of light output than example one. There may be some applications where these features and this type of effect is a desirable quality. These alternatives are shown in greater detail in FIGS. 6-11.

Various patterns to catch and reflect the light can be used. In one example, solid lines and spaces of equal width typically provide an even distribution of light when placed in alignment with the design elements that are to be illuminated. The typical line and gap thickness can range from 0.010″ to 0.060″. The lines may run parallel, perpendicular or at an angle in relation to the position of the source LEDs. Many other patterns may be employed, including dots, circles, and dashed lines of various weights and diameters. In some cases where there are small areas to be illuminated it may be preferred to use a modified version of the actual image area itself as the reflecting feature.

In other implementations, it may be preferred to vary the density of the light reflecting image in order to eliminate a “hot spot,” or to intensify areas that are not as bright as the design would dictate. This can be accomplished by selectively changing the line stroke weight and spacing to achieve the desired effect. The same holds true if the pattern were composed of dots of varying diameters and density.

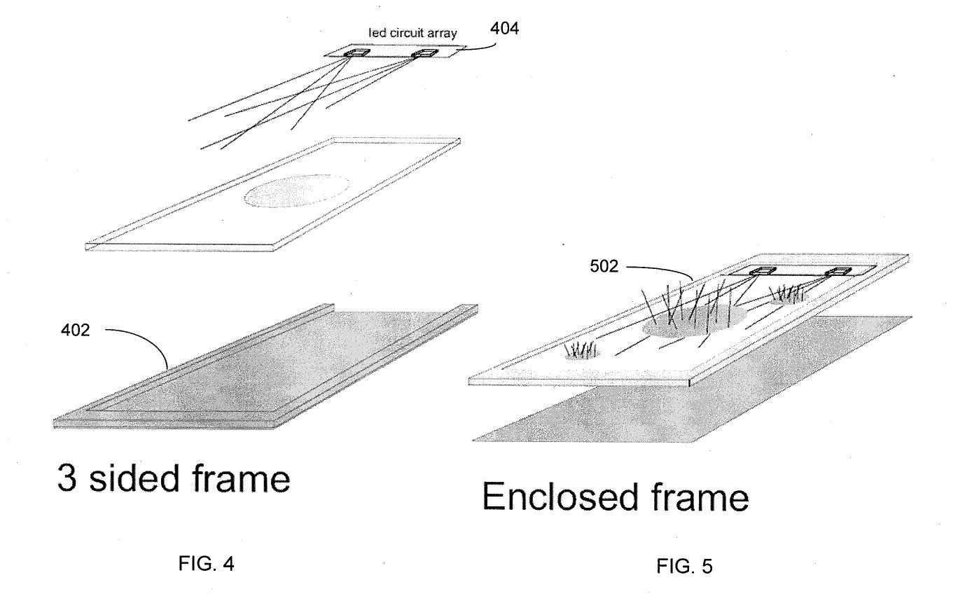

A key component of the light guide assembly is the “opaque white” (or black in the case of light blocking “only” applications/note: this should be a separate detail maybe in an additional section) frame substrate that acts as both a reflector (reflecting light back into the light guide component functionally optimizing the intensity in an area typically the furthest away from the light source and making it possible to achieve a higher intensity of light than would otherwise be possible) while at the same time preventing light from escaping the light guide, which causes undesirable light contamination. FIG. 4 is an exploded view of a light device including a three sided frame 402 with high-intensity, side-emitting, side-positioned LEDs 404. FIG. 5 shows an alternative implementation of a light device having a frame 502 enclosing all sides for complete light containment to prevent unwanted light leakage.

Alternatively, the light guide frame/reflector assembly can be implemented as a device specific plastic component that can be injection molded in white plastic to take essentially the same physical form of the one already described in which a light guide can be inserted. A molded component for this purpose would function substantially the same as the film version, but may be a more cost effective solution for very high volume applications.

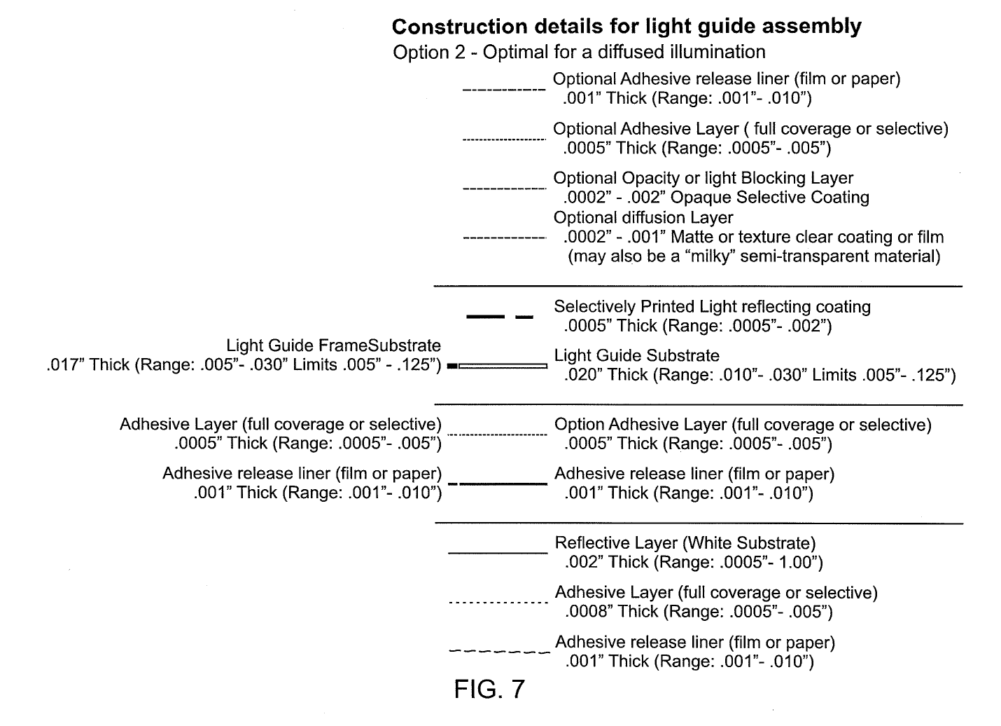

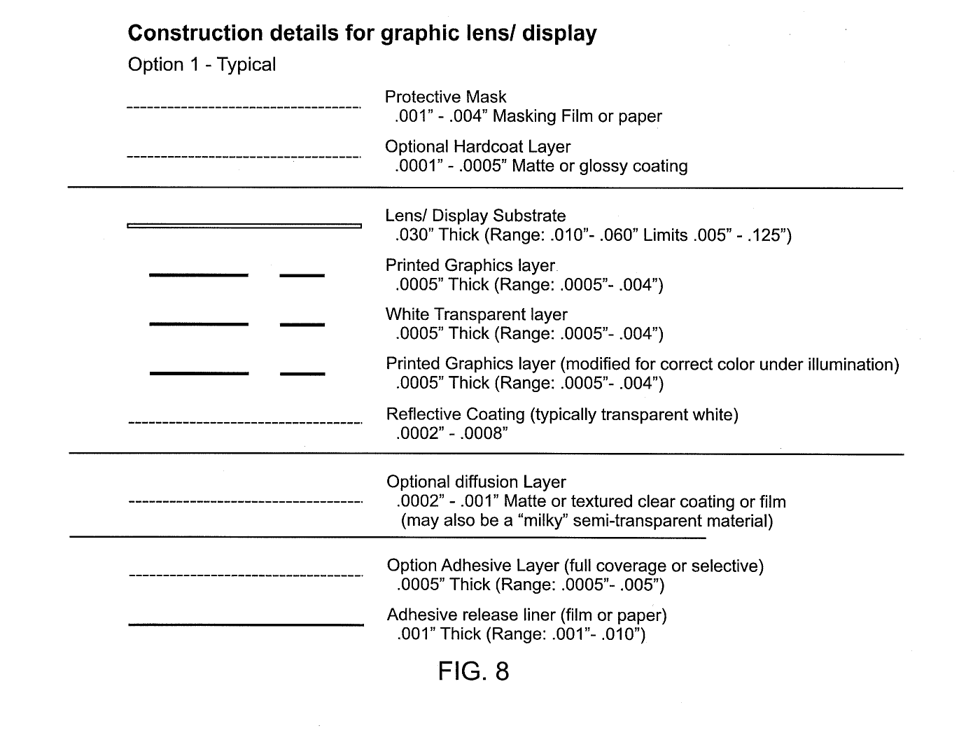

A method of constructing a light guide can incorporate several preferred processes. FIG. 6 illustrates construction details for a light guide assembly that is optimized for a focused illumination. FIG. 7 illustrates construction details for a light guide assembly that is optimized for a diffused illumination. FIG. 8 illustrates construction details for a typical graphic lens/display.

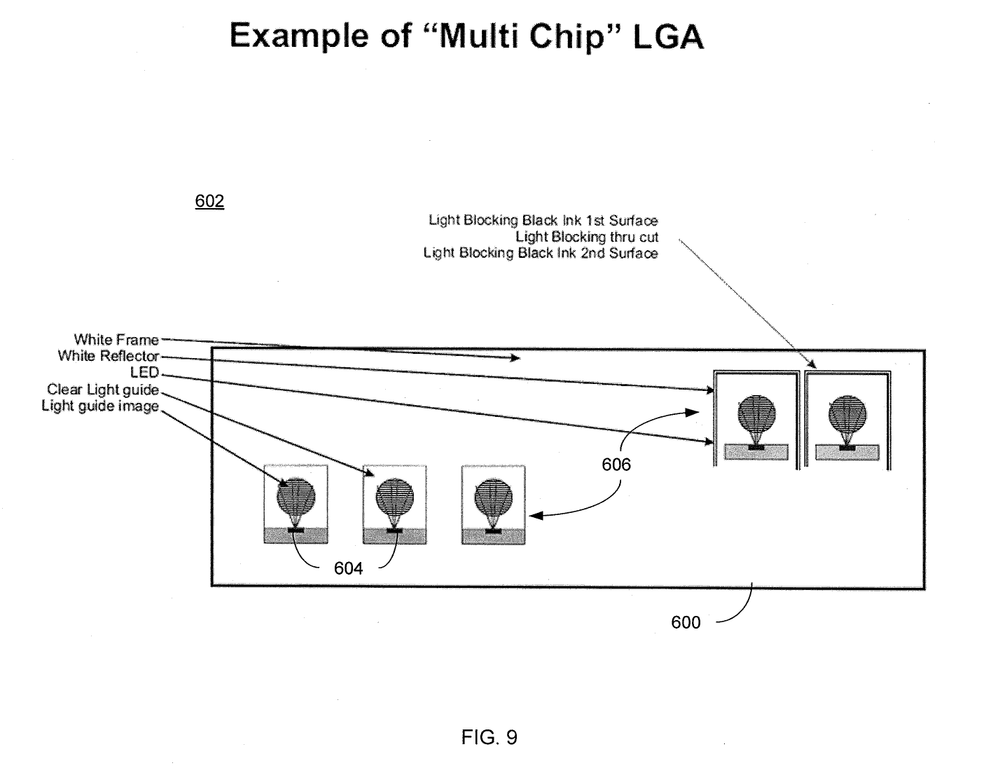

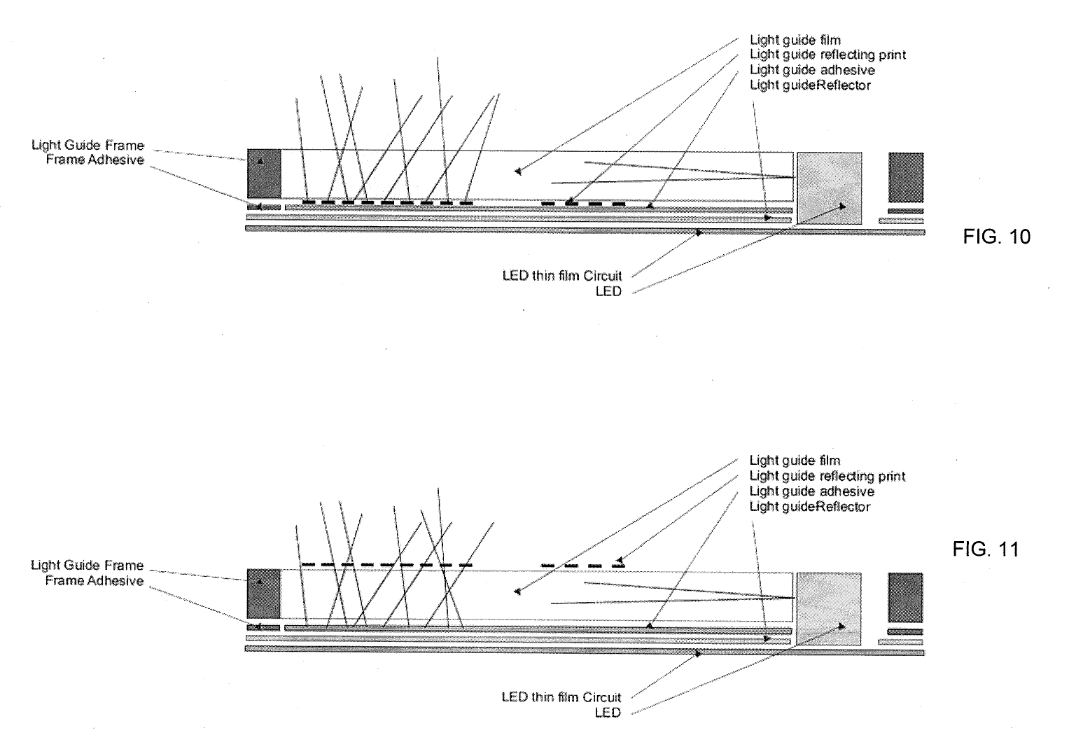

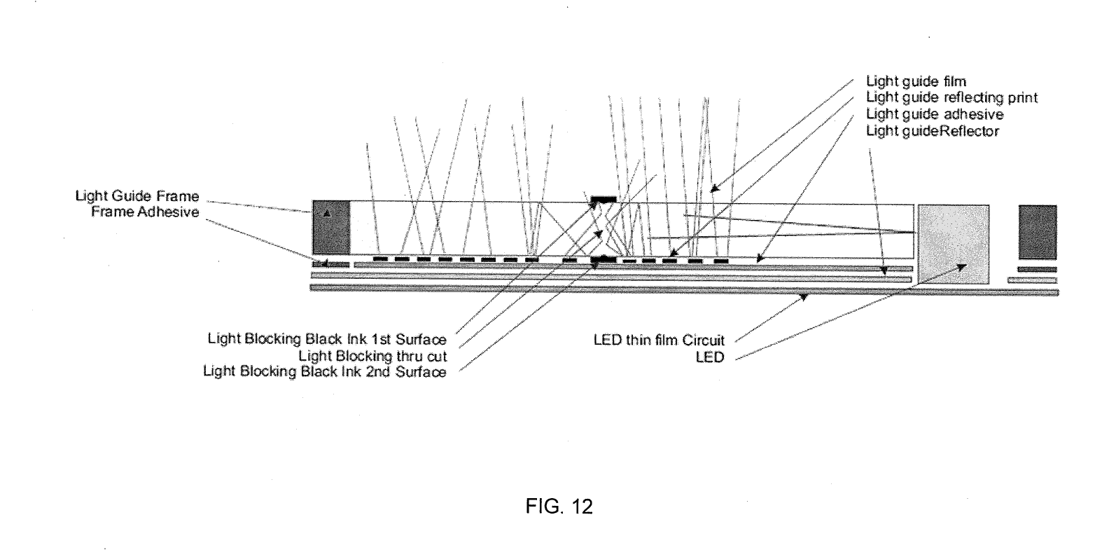

FIG. 9 shows an example of a multi-chip light guide assembly 602 having multiple LEDs 604 and associated light guides 606 positioned within a common frame 600. FIG. 10 illustrates a preferred exemplary implementation of a light guide assembly for focused illumination. FIG. 11 illustrates a preferred exemplary implementation of a light guide assembly for diffused illumination. FIG. 12 illustrates an implementation suitable for light containment.

The devices and techniques described herein allow for even, significantly larger areas of a display or translucent graphic images to be illuminated than could be achieved by an LED alone. Light can also be distributed unevenly if desired, through variations in the light reflective printed pattern to create the desired effect, i.e. brighter in some areas and less intense in other areas. These devices and techniques distribute light to multiple defined areas or points from a single LED that would normally require multiple LED's to illuminate in accordance with their proximity or position from the light source. They also eliminate “hot spots” which are typically a problem when using only a LED for illumination.

Using a light guide as described herein, light can be distributed around curves and in applications that are not flat, or are in an area where an LED is to large to fit in the available space due to design limitations. In other words the light guide film is thin and flexible and can be formed, shaped, or contoured to surfaces that are not flat. Examples include a curved appliance display fascia or control panel. Many displays and control panels today are in fact curved or contoured as a unique design feature and a departure from conventional “flat panels.”

These devices and techniques allow placement of the light guide in precise alignment with switch positions thus illuminating the “keys” of a keypad or control panel without interfering with the switch functionality. The switch technologies compatible with this light guide design are membrane switches, touchpad's and touch capacitive type controls.

In one example, multiple light guides (to be lit by multiple LEDs individually) can be placed into a single light guide reflector/frame assembly thus creating a light guide component with numerous lighting positions that may be illuminated individually or as a group depending on the intended design. In this example it is possible to illuminate specific zones without the possibility of “light leakage” among the zones (a known problem with some light pipe designs).

In some implementations, the light guide is injection molded, and then the reflective areas to be lit are screenprinted or pad printed. In other implementations, the light guide is injection molded as an “in-mold” decorated component using a printed film as the in mold decoration to form the reflective print-like areas.

Although a few embodiments have been described in detail above, other modifications are possible. Other embodiments may be within the scope of the following claims.

1. A light guide for a light-emitting device, the light guide comprising:
a primary guide comprising a thin film of light transmitting material, and having at least one edge to which the light emitting device is connected and into which the light emitting device emits light;
a printed pattern abutting a first side of the primary guide and comprised of light reflecting ink and arranged to reflect the light from the light emitting device.

2. The light guide in accordance with claim 1, further comprising a reflector comprising an opaque layer provided to a first side of the primary guide.

3. The light guide in accordance with claim 2, wherein the printed pattern is printed on the reflector.

4. The light guide in accordance with claim 1, further comprising a guide frame layered onto the reflector and framing the sides of the primary guide.

5. The light guide in accordance with claim 1, further comprising a second printed pattern printed on a second side of the primary guide, opposite the first side of the primary guide, the second printed pattern comprised of light reflecting ink.

6. A light guide comprising:
a thin film of light transmitting material;
a light-emitting device connected to an edge of the thin film;
a printed pattern abutting a first side of the primary guide and comprised of light reflecting ink and arranged to reflect the light from the light emitting device.

7. The light guide in accordance with claim 6, further comprising a reflector comprising an opaque layer provided to a first side of the primary guide.

8. The light guide in accordance with claim 7, wherein the printed pattern is printed on the reflector.

9. The light guide in accordance with claim 6, further comprising a guide frame layered onto the reflector and framing the sides of the primary guide.

10. The light guide in accordance with claim 6, further comprising a second printed pattern printed on a second side of the primary guide, opposite the first side of the primary guide, the second printed pattern comprised of light reflecting ink.

11. A light guide comprising:
a thin film of light transmitting material;
a light-emitting device connected to a first edge of the thin film;
a printed pattern abutting a first side of the primary guide and comprised of light reflecting ink and arranged to reflect the light from the light emitting device; and
a guide frame framing the remaining edges of the primary guide other than the first edge.

12. The light guide in accordance with claim 11, further comprising a liner layer coupled to a first side of the thin film.

13. The light guide in accordance with claim 12, further comprising an image layer coupled to a second side of the thin film opposite the first side.

14. The light guide in accordance with claim 13, wherein the image layer is formed of a plurality of apertures corresponding to the printed pattern.

15. The light guide in accordance with claim 11, wherein the printed pattern is provided to a translucent printed layer that is layered on a first side of the thin film.
